(19) United States
(12) Patent Application Publication
(10) Pub. No.: US 2025/0119733 A1
(43) Pub. Date: Apr. 10, 2025

(54) ENHANCED SECURITY KEYS FOR WI-FI ASSOCIATION FRAMES

(71) Applicant: Intel Corporation, Santa Clara, CA (US)

(72) Inventors: Po-Kai HUANG, San Ramon, CA (US); Ilan PEER, Modiin (IL); Johannes BERG, Detmold (DE); Ido OUZIELI, Tel Aviv (IL); Elad OREN, Tel Aviv (IL); Emily QI, Gig Harbor, WA (US)

(73) Assignee: Intel Corporation, Santa Clara, CA (US)

(21) Appl. No.: 18/984,730

(22) Filed: Dec. 17, 2024

Related U.S. Application Data
(63) Continuation of application No. 17/866,440, filed on Jul. 15, 2022.
(60) Provisional application No. 63/358,641, filed on Jul. 6, 2022.
(60) Provisional application No. 63/222,825, filed on Jul. 16, 2021.

(51) Int. Cl. H04W 12/041; H04W 12/033; H04W 12/0433

(52) U.S. Cl. CPC H04W 12/0433; H04W 12/041; H04W 12/069; H04W 12/106

(57) ABSTRACT

This disclosure describes systems, methods, and devices related to using encrypted 802.11 association. A device may identify a beacon received from an access point (AP), the beacon including an indication of an authentication and key manager (AKM); transmit, to the AP, an 802.11 authentication request including an indication of parameters associated with the AKM; identify an 802.11 authentication response received from the AP based on the 802.11 authentication request, the 802.11 authentication response including a message integrity check (MIC) using a key confirmation key (KCK) and an indication that the parameters have been selected by the AP; transmit, to the AP, an 802.11 association request encrypted by a security key based on an authenticator address of the AP; and identify an 802.11 association response received from the AP based on the 802.11 association request, the 802.11 association response encrypted by the security key.

### CROSS-REFERENCE TO RELATED PATENT APPLICATION(S)

This application is a continuation of U.S. Non-Provisional application Ser. No. 17/866,440, filed Jul. 15, 2022, which claims the benefit of U.S. Provisional Application No. 63/358,641, filed Jul. 6, 2022, and U.S. Provisional Application No. 63/222,825, filed Jul. 16, 2021, the disclosures of which are incorporated by reference as set forth in full.

### TECHNICAL FIELD

This disclosure generally relates to systems and methods for wireless communications and, more particularly, to security keys used for Wi-Fi association frames.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1A is a network diagram illustrating an example network environment of multi-link devices (MLDs), in accordance with one or more example embodiments of the present disclosure.

FIG. 1B depicts an illustrative schematic diagram for MLD communications between two logical entities, in accordance with one or more example embodiments of the present disclosure.

FIG. 1C depicts an illustrative schematic diagram for MLD communications between an access point (AP) MLD with logical entities and a non-AP MLD with logical entities, in accordance with one or more example embodiments of the present disclosure.

FIG. 2 depicts a process for using protected Wi-Fi association based on a protected Wi-Fi pre-association exchange, in accordance with one or more example embodiments of the present disclosure.

FIG. 3 illustrates example state machines of a Wi-Fi device for association and authentication, in accordance with one or more example embodiments of the present disclosure.

FIG. 4 illustrates a flow diagram of illustrative process for using protected Wi-Fi association based on a protected Wi-Fi pre-association exchange, in accordance with one or more example embodiments of the present disclosure.

FIG. 5 illustrates a functional diagram of an exemplary communication station that may be suitable for use as a user device, in accordance with one or more example embodiments of the present disclosure.

FIG. 6 illustrates a block diagram of an example machine upon which any of one or more techniques (e.g., methods) may be performed, in accordance with one or more example embodiments of the present disclosure.

FIG. 7 is a block diagram of a radio architecture in accordance with some examples.

FIG. 8 illustrates an example front-end module circuitry for use in the radio architecture of FIG. 7, in accordance with one or more example embodiments of the present disclosure.

FIG. 9 illustrates an example radio IC circuitry for use in the radio architecture of FIG. 7, in accordance with one or more example embodiments of the present disclosure.

FIG. 10 illustrates an example baseband processing circuitry for use in the radio architecture of FIG. 7, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The IEEE 802.11 technical standards define Wi-Fi communications, including secure transmissions of wireless frames. The 802.11az standard introduced a pre-association security negotiation (PASN) exchange that allowed for protecting negotiation and measurement result frames sent between station devices (STAs) and access points (APs) without requiring a Wi-Fi STA to be associated to an AP. After the security context is established using PASN, a fine timing measurement (FTM) session and location measurement reports (LMRs) may be protected (e.g., protected management frames—PMFs). In particular, the transient key (TK) derived by PASN is used to protect FTM and LMR frames in 802.11az.

PASN is an robust security network association (RSNA) authentication protocol that relies on the existence of a pair-wise master key security association (PMSKA) for authentication and key management (AKM), referred to as a base AKM for PASN. PASN is a non-RSNA protocol when there is no PMKSA and corresponding base AKM. PASN primarily is used in AP infrastructure networks for a STA and an AP to establish a PTKSA using a three-message authentication exchange (e.g., authentication request, authentication response, authentication confirmation). PASN leverages a cached PMK for a base AKM to establish the PMKSA from which the PASN PTKSA is derived. PASN authentication does not derive a group transient key security association (GTKSA) or integrity GTKSA (IGTKSA), for example.

PASN defined by 802.11az includes a STA discovery of an AP with PASN capability (e.g., as indicated by a beacon), an authentication request sent by the STA (e.g., supplicant), an authentication response sent by the AP (e.g., authenticator), and an authentication confirmation sent by the STA. The key derivation procedure for the pairwise key hierarchy in PASN is KCK∥TK∥KDK=KDF-HASH-NNN (PMK, “PASN PTK Derivation”, SPA∥BSSID∥DHss), where KCK is the key confirmation key, KDK is the key derivation key, KDF is the key derivation function, PMK is the pairwise master key, PTK is the pairwise transient key, SPA is the supplicant address, BSSID is the identifier of the basic service set provided by the AP, and DHss is the direct-sequence spread spectrum. Unlike the traditional four-way handshake, where KCK is used for integrity check/protection of an extensible authentication protocol over local area network (EAPOL)-key frame, the KCK here in PASN is used for integrity check/protection of the second and third PASN frames of the PASN exchange (e.g., the authentication response and the authentication confirmation). TK is used to protect frame like FTM, and KDK is used to derive an additional key for a secure long training field (LTF) of a frame. The state machine for a Wi-Fi STA was modified in 802.11az to include a new state in which the STA may be authenticated to an AP by PASN, but is still unassociated to the AP until the STA performs an 802.11 non-PASN authentication (or a fast initial link setup authentication) and subsequent association.

However, PASN defined by 802.11az does not apply to association frames. In 802.11, association is a process that allows an AP to maintain a record of a station device (STA) to ensure that frames are delivered to the STA. In 802.11, association includes an association request and response exchange that follows an authentication request and response exchange. PASN defined by 802.11az applies to the authentication request/response exchange, but does not apply to the association request sent by the STA and to the association response sent by the AP.

There is a need to encrypt association frames because element fingerprints may be used on association frames to enable tracking. Because PASN currently is allowed only in pre-association, the key developed by PASN is not used to protect (re)association request/response frames. There is no previous solution to enable PASN to encrypt (re)association request/response frame.

Example embodiments of the present disclosure relate to systems, methods, and devices for deriving and using security keys with which to protect Wi-Fi association frames.

In one or more embodiments, a Wi-Fi device may derive a security key with which to encrypt (re)association request/response frames. The authentication request and response messages from 802.11az PASN may be reused to derive a security key with which to encrypt (re)association request/response frames. In particular, one bit in the authentication request (e.g., used for the PASN parameters) may be used to indicate the difference from PASN to a new mode used to encrypt (re)association request/response frames. When using the new mode, the authentication confirmation message from the PASN process may be replaced with a (re)association request followed by a (re)association response. When the new mode does not use the PMK identifier (PMKID) from PASN, the content in the authentication confirmation message of PASN may be tunneled into a (re)association request message. When using the new mode, the key derivation formula may use the authenticator address (AA) instead of the BSSID, and the key derivation formula may derive an additional key other than TK with which to encrypt the (re)association request, or may use TK (e.g., TK may be the key used for encryption of other data management frames sent after association). When using the new mode, after the four-way handshake, the STA state may be updated to the third state of the STA state machine (e.g., a state in which the STA has been both authenticated and associated). When using the new mode, the STA may go from state 1 of the state machine (e.g., unauthenticated and unassociated) directly to state 3 of the state machine (e.g., authenticated and associated). State 1a of the STA state machine (e.g., authenticated using PASN, but not associated) may still be allowed, and the new mode may allow the STA to go from state 1a to state 3. Once in state 3, disassociation of the STA may return the STA to state 2 (e.g., authenticated using a non-PASN authentication, and unassociated, even when the STA skipped state 2), and PTSKA derivation may be deleted. The STA transition from state 2 to state 3 may still be allowed under the new mode. In this manner, the STA state machine may be updated from 802.11az. When using the new mode, when the PMKID maps to a PMK in the PASN authentication request or response message, the device may change the PMKID maps to the same PMK by delivering new PMKID maps to the same PMK, or the old PMKID maps to the same PMK with the new encrypted/scrambled version in the PASN authentication response or (re)association response that may replace the PASN authentication confirmation.

In one or more embodiments, a PASN exchange system may allow the transient key (TK) derived during PASN exchange to encrypt the (re)association request/response frame.

In one or more embodiments, when 802.1X is needed, a traditional sequence to perform 802.1X is required, and then PMKID is derived to be used under PASN sequence to derive a pairwise key hierarchy.

In one or more embodiments, over-the-air fast transition (FT) protocol is used, the over-the-air FT protocol can be directly used rather than the PASN sequence to encrypt the (re)association request/response frame.

In one or more embodiments, when the supplicant has PMKID and intends to proceed directly to association after PTKSA derivation, then only the four-message exchange is needed rather than five messages under a PASN exchange.

In one or more embodiments, a (re)association request/response frame can be encrypted using the TK derived by PASN exchange.

In one or more embodiments, the protection of (re)association frames may apply to multi-link devices. In particular, the IEEE 802.11 technical standards provide techniques for multi-link devices (MLDs) with STR capabilities. A station (STA) may refer to a logical entity that is a singly addressable instance of a medium access control (MAC) and physical layer (PHY) interface to the wireless medium (WM). A communication link (or just “link”) in the context of an IEEE 802.11 medium access control (MAC) entity, may refer to a physical path consisting of exactly one traversal of the wireless medium (WM) that is usable to transfer MAC service data units (MSDUs) between two STAs. In multi-link communications, a multi-link device (MLD), also referred to as a multi-link logical entity (MLLE), may refer to a device that has more than one affiliated STA and that has a medium access control (MAC) layer (e.g., of a communication layer stack) service access point (SAP) to a logical link control (LLC), which may include a MAC data service. An AP MLD (A MLD) may refer to an AP device, where each STA affiliated with the STA MLD is an AP. A non-AP ML device (non-AP MLD) maybe an A MLD, where each STA affiliated with the MLD is a non-AP STA. A MLD may be considered a logical/virtual entity with multiple STAs (e.g., AP STAs or non-AP STAs), and each STA concurrently may use separate communication links with corresponding STAs of another MLD. In this manner, a MLD may communicate over multiple communication links concurrently without having to drop one communication link to allow for establishing another communication link. Multi-link operation (MLO) is an important 802.11be feature, which allows a device to communicate to another device using multiple links on different channels/bands. A device supporting multiple links is a MLD.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

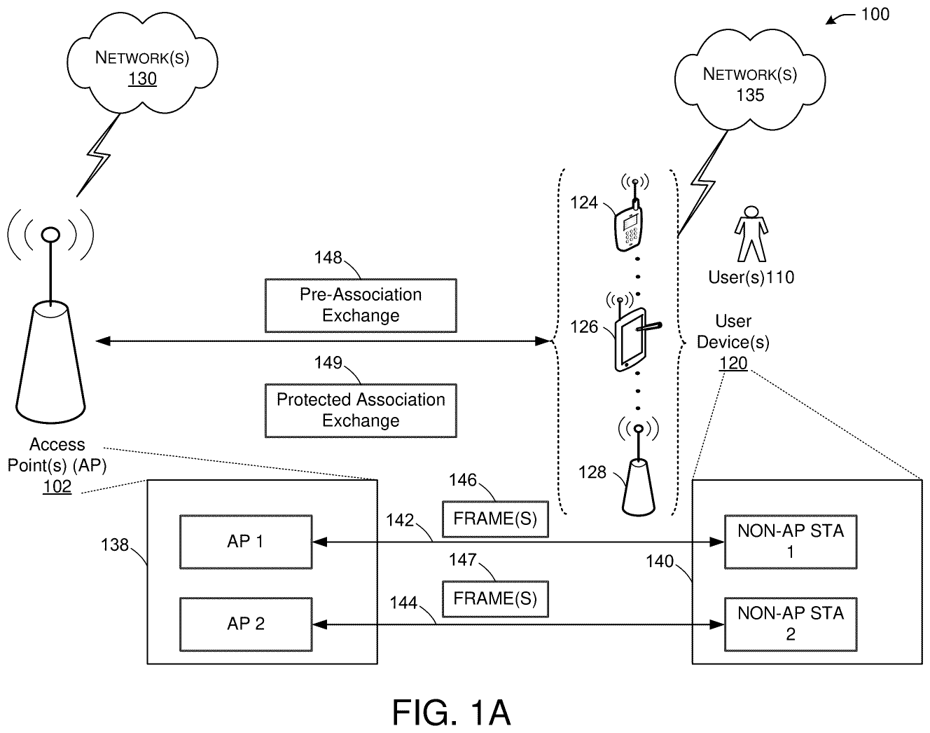

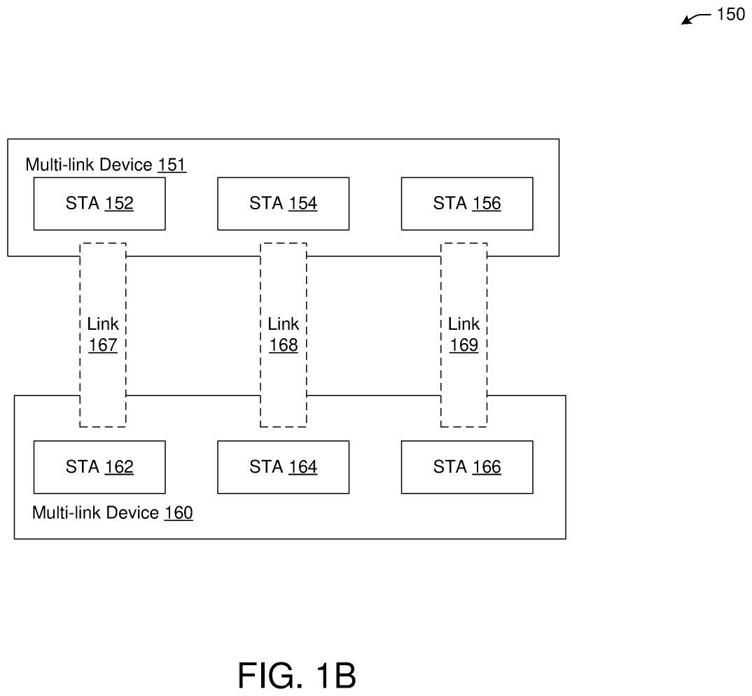

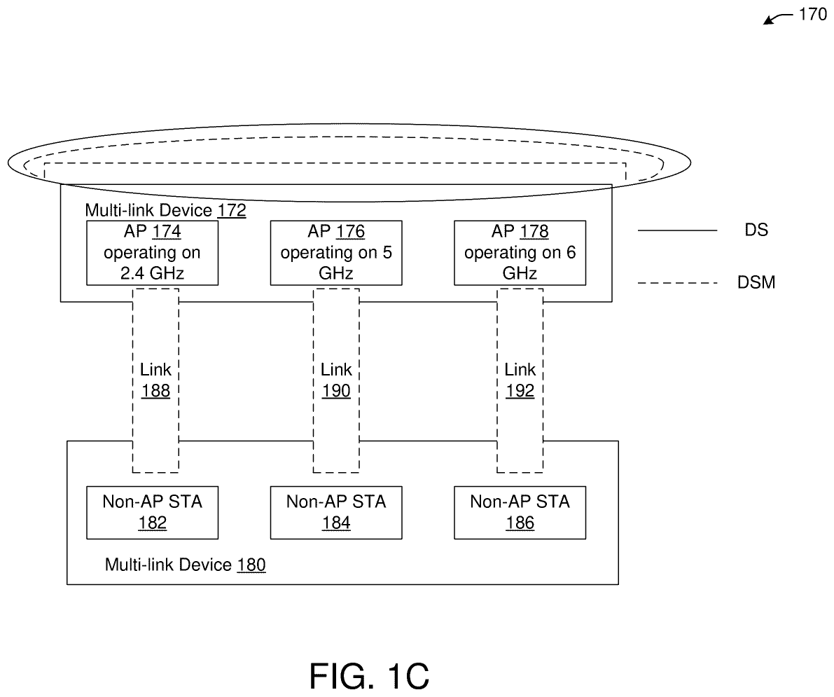

FIG. 1A is a network diagram illustrating an example network environment 100 of MLDs, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

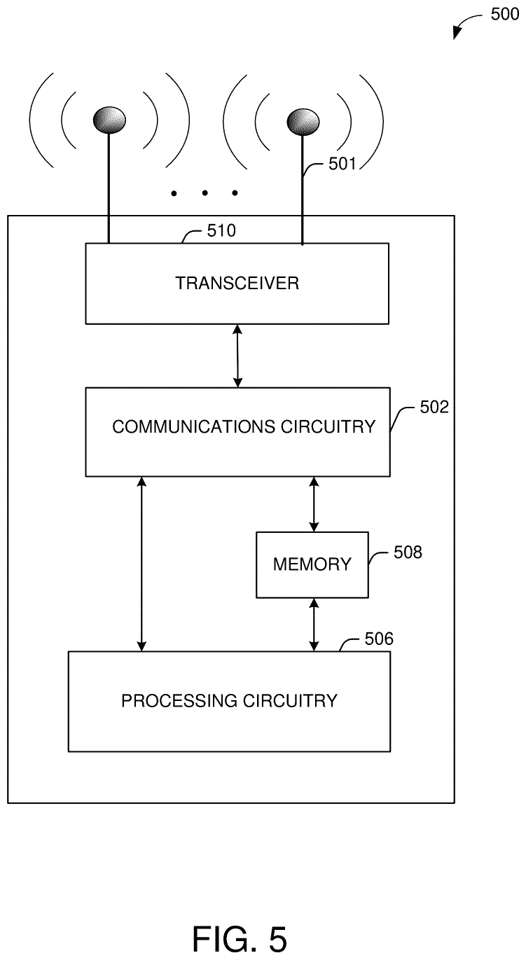

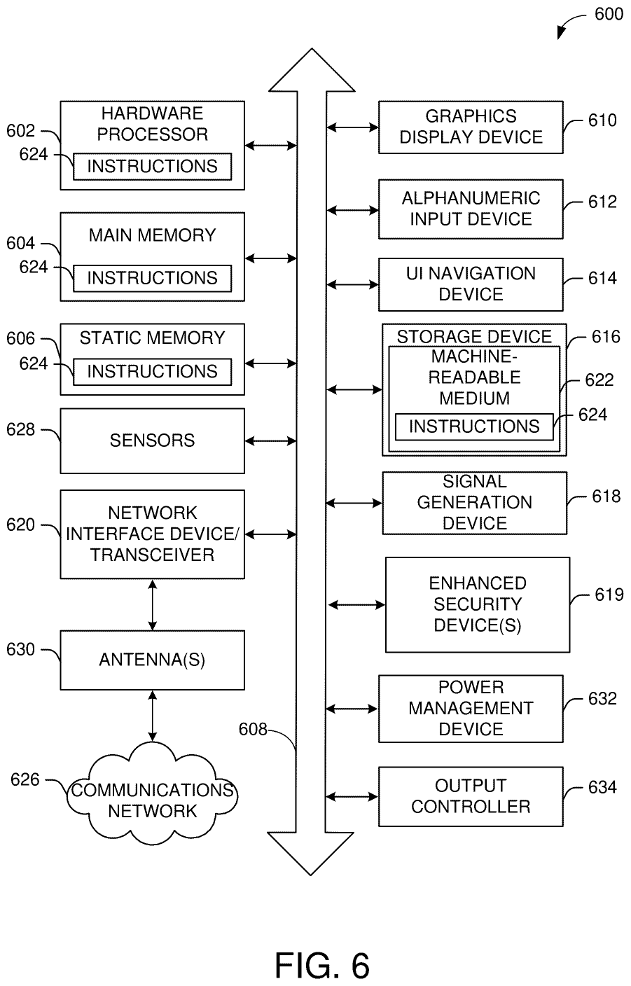

In some embodiments, the user devices 120 and the AP 102 may include one or more computer systems similar to that of the functional diagram of FIG. 5 and/or the example machine/system of FIG. 6.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QOS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1A, AP 102 may be considered an A MLD 138 logical/virtual entity with multiple AP STAs (e.g., AP 1 and AP 2), and a user device of the user devices 120 may be considered a MLD 140 logical/virtual entity with multiple non-AP STAs (e.g., non-AP STA 1 and non-AP STA 2). A first link 142 may be established between the AP 1 and the non-AP STA 1, and a second link 144 may be established between the AP 2 and the non-AP STA 2. Both the first link 142 and the second link 144 may be used simultaneously (e.g., the AP 102 and/or the user device 120 do not need to drop one of the links to use the other link). One or more frames 146 may be sent across the first link 142, and one or more frames 147 may be sent across the second link 144.

In one or more embodiments, to provide a non-collocated MLD environment, the AP(s) 102 may represent multiple multi-link sets (e.g., as shown in FIGS. 1B and 1C), with the multi-link sets being in communication with a controller.

In one embodiment, and with reference to FIG. 1A, a user device 120 may be in communication with one or more of the APs 102. For example, one or more APs 102 may implement a pre-association exchange 148 with one or more user devices 120, in which a user device 120 may authenticate to an AP 102 (e.g., using a secure authentication request/response exchange as defined by PASN in 802.11az). After the pre-association exchange 148, the user device 120 and the AP 102 may perform a protected association exchange 149 (e.g., an association request/response exchange) in which the association frames between the user device 120 and the AP 102 may be protected based on the security key protection of the pre-association exchange 148.

In one embodiment, the one or more APs 102 may be multi-link devices (A-MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs, as described further with respect to FIGS. 1B and 1C.

FIG. 1B depicts an illustrative schematic diagram for MLD communications 150 between two logical entities, in accordance with one or more example embodiments of the present disclosure.

Referring to FIG. 1B, there are shown two MLDs in communication with each other.

MLD 151 may include multiple STAs (e.g., STA 152, STA 154, STA 156, etc.), and MLD 160 may include multiple STAs (e.g., STA 162, STA 164, STA 166, etc.). The STAs of the MLD 151 and the STAs of the MLD 160 may set up links with each other (e.g., link 167 for a first frequency band used by the STA 152 and the STA 162, link 168 for a second frequency band used by the STA 154 and the STA 164, link 169 for a second frequency band used by the STA 156 and the STA 166). In this example of FIG. 1B, the two MLDs may be two separate physical devices, where each one comprises a number of virtual or logical devices (e.g., the STAs).

FIG. 1C depicts an illustrative schematic diagram for MLD communications 170 between an AP MLD with logical entities and a non-AP MLD with logical entities, in accordance with one or more example embodiments of the present disclosure.

Referring to FIG. 1C, there are shown two MLDs on either side, each which includes multiple STAs that can set up links with each other. For infrastructure framework, MLD 172 may be an A-MLD with logical APs (e.g., AP 174, AP 176, and AP 178) on one side, and MLD 180 may be a non-AP MLD including non-AP logical entities (non-AP STA 182, non-AP STA 184, and non-AP STA 186) on the other side. The detailed definition is shown below. It should be noted that the term MLLE and MLD are interchangeable and indicate the same type of entity. Throughout this disclosure, MLLE may be used but anywhere the MLLE term is used, it can be replaced with MLD. Multi-link non-AP logical entity (non-AP MLLE, also can be referred to as non-AP MLD): A multi-link logical entity, where each STA within the multi-link logical entity is a non-AP EHT STA. It should be noted that this framework is a natural extension from the one link operation between two STAs, which are AP and non-AP STA under the infrastructure framework (e.g., when an AP is used as a medium for communication between STAs).

In the example of FIG. 1C, the MLD 172 and the MLD 180 may be two separate physical devices, where each one comprises a number of virtual or logical devices. For example, the multi-link AP logical entity may comprise three APs, AP 174 operating on 2.4 GHz (e.g., link 188), AP 176 operating on 5 GHz (e.g., link 190), and AP 178 operating on 6 GHz (e.g., link 192). Further, the multi-link non-AP logical entity may comprise three non-AP STAs, non-AP STA 182 communicating with AP 174 on link 188, non-AP STA 184 communicating with AP 176 on link 190, and non-AP STA 186 communicating with AP 178 on link 192.

The MLD 172 is shown in FIG. 1C to have access to a distribution system (DS), which is a system used to interconnect a set of BSSs to create an extended service set (ESS). The MLD 172 is also shown in FIG. 1C to have access a distribution system medium (DSM), which is the medium used by a DS for BSS interconnections. Simply put, DS and DSM allow the AP to communicate with different BSSs.

It should be understood that although the example shows three logical entities within the MLD 172 and the three logical entities within the MLD 180, this is merely for illustration purposes and that other numbers of logical entities with each of the MLDs may be envisioned.

It is understood that the above descriptions are for purposes of illustration and are not meant to be limiting.

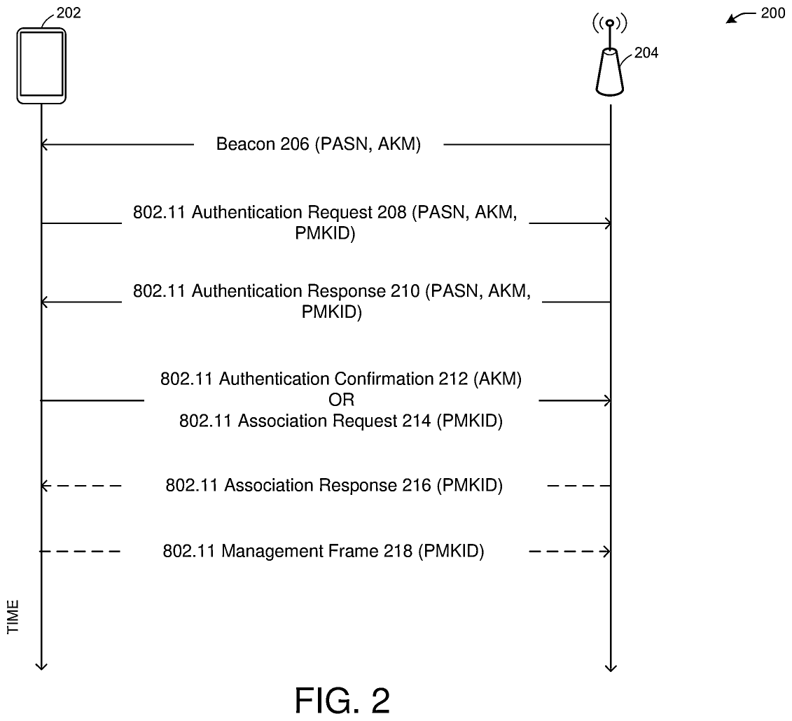

FIG. 2 depicts a process 200 for using protected Wi-Fi association based on a protected Wi-Fi pre-association exchange, in accordance with one or more example embodiments of the present disclosure.

Referring to FIG. 2, a STA 202 may authenticate and associate to an AP 204. The AP 204 may broadcast its networks and capabilities in a beacon 206. The beacon 206 may indicate PASN capabilities of the AP 204, including a PASN alliance key manager (AKM) and a base AKM, and may include a robust security network element (RSNE) to indicate a capability of creating robust security network associations (RSNAs). After the STA 202 discovers the AP 204, the STA 202 may generate and send an 802.11 authentication request 208, requesting authentication to the AP 204. The 802.11 authentication request 208 may initiate an 802.11az PASN procedure (e.g., making the STA 202 the supplicant device and the AP 204 the authenticator). The 802.11 authentication request 208 may include an indication of PASN capabilities, RSNE parameters (e.g., base AKM parameters from among those advertised by the beacon 206, PMKID, PASN parameters). The AP 204 may respond by generating and sending an 802.11 authentication response 210 to the STA 202. The 802.11 authentication response 210 may include an indication of PASN capabilities, RSNE parameters (e.g., selected base AKM parameters from the base AKM parameters provided by the 802.11 authentication request 208, PMKID, PASN parameters). If the AP 204 successfully processes the 802.11 authentication request 208, the 802.11 authentication response 210 may include chosen base AKM parameters, including a chosen PMKID (possibly none), the AP's ephemeral public key, PASN parameters, and any additional base AKM specific data. The 802.11 authentication response 210 may be integrity protected using a message integrity check (MIC) with a key confirmation key (KCK). A successful exchange of the 802.11 authentication request 208 and the 802.11 authentication response 210 may result in establishment of a PTSKA using the ephemeral keys and PMK from the base AKM (if any).

Still referring to FIG. 2, an 802.11az PASN process may continue with the STA 202 generating and sending an 802.11 authentication confirmation 212 using the base AKM data for security. However, when the 802.11 authentication request 208 includes a bit of the PASN parameters indicating that a new mode for secure association may be used, then the 802.11 authentication confirmation 212 may be replaced by an 802.11 association request 214, followed by an 802.11 association response 216 from the AP 204, and optionally followed by secure 802.11 management frames 218 sent by the AP 204. The 802.11 association request 214 and the 802.11 association response 216 may be re-association requests and responses.

In one or more embodiments, when using the new secure association mode without PMKID, the content of the 802.11 authentication confirmation 212 may be tunneled into the 802.11 association request 214.

In one or more embodiments, when using the new secure association mode, the key derivation formula used by the AP 204 and the STA 202 may use the authenticator address of the AP 204 rather than the BSSID that is used in the PASN exchange (e.g., in the 802.11 authentication request 208 and the 802.11 authentication response 210). The key derivation formula may derive an additional key other than TK to encrypt the 802.11 association request 214, or may use TK. TK may be the key used for encrypting other post-association data management frames (e.g., the 802.11 management frames 218). In this manner, the 802.11 association request 214 and the 802.11 association response 216 may be encrypted in part based on the encryption that occurs before association (e.g., at least a portion of the 802.11az PASN process including the authentication request/response exchange).

In one or more embodiments, the TK derived during PASN exchange (e.g., the authentication request/response exchange) may be used to encrypt the (re)association request/response frame exchange using symmetric cryptography. An element that includes a sub-element for GTK/IGTK/BIGTK can be provided in the 802.11 association response frame 216. The BSSID in the pairwise hierarchy derivation may be replaced with the address of the authenticator. This sequence is only allowed if PMKSA already exists or is derived from the PASN exchange, i.e., a RSNA protocol. BSSID in the key derivation is replaced with AA, which is the authenticator address. The PTKSA derived used PASN may be deleted after disassociation. Later, to encrypt the 802.11 association request frame 214, another PASN (e.g., authentication) exchange using PMK caching may be required. If PMKID is used by PASN to derive PTKSA, then after the end of the PASN exchange, a PMKID change procedure is performed on both supplicant and authenticator.

In one or more embodiments, if protected PMKID is used by PASN to derive PTKSA, i.e., a protected PMKID is carried in the first authentication of PASN exchange, then the AP 204 may deliver another protected PMKID. The protected PMKID can be delivered in protected (re)association response frame (e.g., the 82011 association response 216) by utilizing a sub-element. If an acknowledgement (not shown) of the 802.11 association response 216 is sent by the STA 202, then the new protected PMKID is used later. If an acknowledgement (not shown) of the 802.11 association response 216 is received by the STA 202, then the new protected PMKID is used later. The protected PMKID can be delivered in the second authentication frame of the PASN exchange (e.g., the 802.11 authentication response 210). If an acknowledgement of the second authentication frame is sent by the STA 202 (e.g., the 802.11 authentication confirmation 212), then the new protected PMKID is used later. If acknowledgement of the second authentication frame (e.g., the 802.11 authentication confirmation 212) is received by the STA 202, then the new protected PMKID is used later.

In one or more embodiments, if PMKID is carried by PASN (e.g., the 802.11 authentication request/response exchange) to derive PTKSA, and the STA 202 wants to proceed to a (re)association request/response exchange after PASN, then the STA 202 may send the 802.11 association request 214 directly rather than the 802.11 authentication confirmation 212 of the original PASN exchange. Based on the existing 802.11az, when PMKID is used, the 802.11 authentication confirmation 212 is used to confirm that the authentication request/response exchange is successful. No other information is need. As a result, the 802.11 association request 214 can directly indicate that the exchange is successful (e.g., in place of the 802.11 authentication confirmation 212). This can be automatic when PMKID is used. One bit in a control field of a PASN Parameters element in the 802.11 authentication request 208 can be used to indicate that 802.11 association request 214 will replace the 802.11 authentication confirmation 212 of PASN to directly go to (re)association request/response exchange. Otherwise the STA 202 begins the construction the third PASN frame (e.g., the 802.11 authentication confirmation 212) as follows: Using Section 9.4.1.1 (Authentication Algorithm Number field) of 802.11az set to 7 (PASN Authentication); 9.4.1.2 (Authentication Transaction Sequence Number field) set to 3; status code indicating success; constructs and includes in the third PASN frame; 9.4.2.303 (PASN Parameters Element) with the wrapped data format. Public Key information and Comeback Information fields shall not be present. The Control field in the element is set appropriately to indicate the presence or absence of fields in the element. Section 9.4.2.187 (Wrapped Data Element) corresponding to Base AKM data to be returned to the non-AP STA, if any. This element may be fragmented using mechanism specified in 10.28.11 (Element fragmentation) as necessary. Include an OCI Element containing an OCI element as defined in Section 9.4.2.236 (OCI element). Section 9.4.2.118 (A MIC element) with MIC computed as specified in 12.8 (MIC computation for the 802.11 authentication confirmation 212).

In one or more embodiments, without PMKID, the 802.11 association request 214 may replace the 802.11 authentication confirmation 212, with the 802.11 association response 216 resulting in a four-way handshake (e.g., the authentication request/response exchange and the association request/response exchange). The pairwise key hierarchy may be updated as follows to use KEK, where the “PASN PTK derivation” string may be preplaced with other strings for the new sequence: KCK∥KEK∥TK∥KDK=KDF-HASH-NNN (PMK, “PASN PTK Derivation”, SPA∥AA∥DHss), where key-encryption-key KEK (e.g., TK or an additional key as described above) may be used to encrypt the 802.11 association request 214 and the 802.11 association response 216. A PASN parameters element and a wrapped data element may be included in the 802.11 association request 214, and the AP 204 may process them as it would the 802.11 authentication confirmation 212.

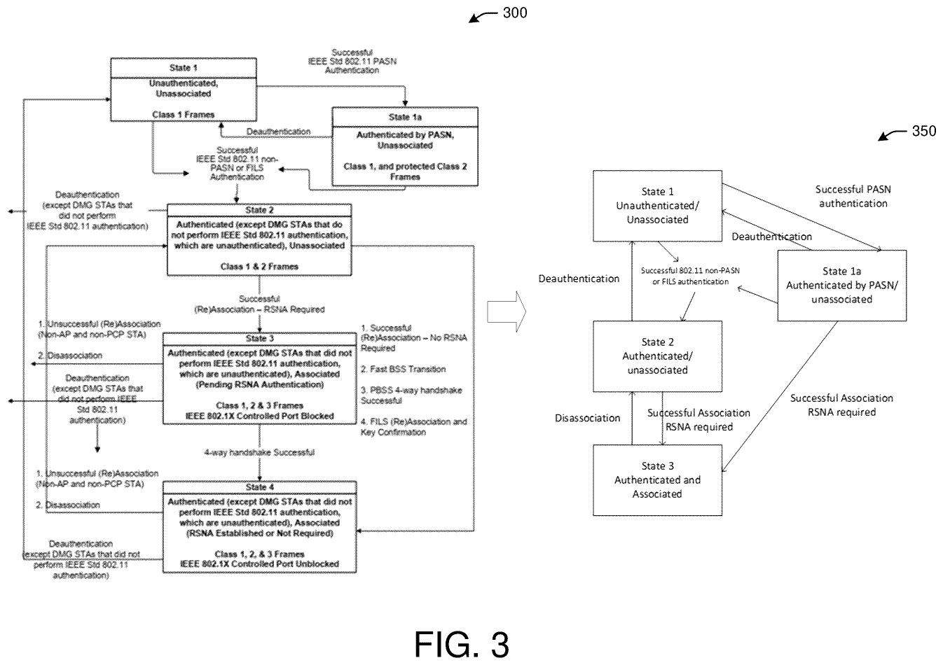

FIG. 3 illustrates example state machines of a Wi-Fi device for association and authentication, in accordance with one or more example embodiments of the present disclosure.

Referring to FIG. 3, state machine 300 is used for PASN in 802.11az, and state machine 350 represents an updated state machine with the protection of association frames (e.g., corresponding to the process 200 of FIG. 2). The state machine 300 is updated to the state machine 350 to enable the usage of the TK derived by PASN (e.g., the 802.11 authentication request/response exchange of FIG. 2) to encrypt (re)association request/response frames. State 1a may go to state 3 through a successful exchange of (re)association request/response frames. State 3 after disassociation will go to state 2 like before rather than going to state 1a. State 1a and state 2 only have a difference of being with/without valid PTKSA. Once the STA 202 of FIG. 2 disassociates from state 3, then PTKSA is deleted, and the STA 202 returns to state 2.

In one or more embodiments, both sides enter state 1a after a (re)association request frame. Then, both sides enter state 3 after a (re)association response frame. (Or directly go state 3). After the four-message exchange of FIG. 2 (e.g., the authentication request/response exchange and the association request/response exchange), the STA 202 may go directly to state 3. The STA 202, under the new mode, may go from state 1 to state 3, or from state 1a to state 3. Once in state 3, dissociation may return the STA 202 to state 2, where PTKSA derivation is deleted. From state 2, the STA 202 may proceed to state 3.

It is understood that the above descriptions are for purposes of illustration and are not meant to be limiting.

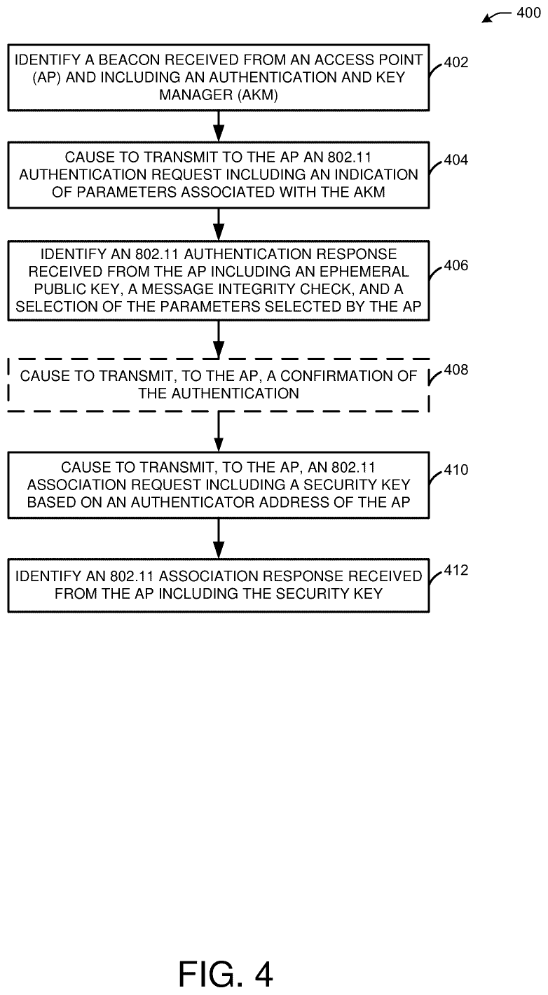

FIG. 4 illustrates a flow diagram of illustrative process 400 for using protected Wi-Fi association based on a protected Wi-Fi pre-association exchange, in accordance with one or more example embodiments of the present disclosure.

At block 402, a device (e.g., a user device 120 of FIG. 1A, the MLD 151 or the MLD 160 of FIG. 1B, the MLD 180 of FIG. 1C, the STA 202 of FIG. 2, the enhanced security device 619 of FIG. 6) may identify a beacon (e.g., the beacon 206 of FIG. 2) received from an AP (e.g., the AP 204 of FIG. 2), the beacon including PASN capabilities of the AP, including a PASN alliance key manager (AKM) and a base AKM, and including a robust security network element (RSNE) to indicate a capability of creating robust security network associations (RSNAs).

At block 404, the device may cause to transmit an 802.11 authentication request (e.g., the 802.11 authentication request 208 of FIG. 2) including a RSNE that contains Base AKM parameters including a list of PMKIDs (possibly empty), STA's ephemeral public key, PASN parameters, and additional Base AKM specific data, if any.

At block 406, the device may identify an 802.11 authentication response (e.g., the 802.11 authentication response 210 of FIG. 2) received from the AP. The 802.11 authentication response may include a RSNE that contains chosen Base AKM parameters including the chosen PMKID (possibly none), AP's ephemeral public key, PASN parameters, and additional Base AKM specific data, if any. The 802.11 authentication response is also integrity protected with a MIC using the Key Confirmation key (KCK).

At block 408, the device optionally may cause to transmit to the AP a confirmation of the authentication (e.g., the 802.11 authentication confirmation 212 of FIG. 2). Alternatively, the next frame sent after the 802.11 authentication request may be an association frame. For example, at block 410, the device may cause to transmit an 802.11 association request (e.g., the 802.11 association request 214 of FIG. 2) that may be encrypted either using the TK derived from the authentication request/response exchange, or another key. The key for the 802.11 association request may be derived using an authenticator address of the AP instead of the BSSID of a BSS provided by the AP. When the 802.11 association request replaces the authentication confirmation, the authentication confirmation may be tunneled into the 802.11 association request so that the 802.11 association request confirms the authentication of the device to the AP.

At block 412, the device may identify an 802.11 association response (e.g., the 802.11 association response 216 of FIG. 2) received from the AP, based on the 802.11 association request, associating the device to the AP. The 802.11 association response may use the security key.

It is understood that the above descriptions are for purposes of illustration and are not meant to be limiting.

FIG. 5 shows a functional diagram of an exemplary communication station YY00, in accordance with one or more example embodiments of the present disclosure. In one embodiment, FIG. 5 illustrates a functional block diagram of a communication station that may be suitable for use as an AP 102 (FIG. 1A) or a user device 120 (FIG. 1A) in accordance with some embodiments. The communication station 500 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer (PHY) communications and/or medium access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in the above figures, diagrams, and flows.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device, read-only memory (ROM), random-access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device.

FIG. 6 illustrates a block diagram of an example of a machine 600 or system upon which any one or more of the techniques (e.g., methodologies) discussed herein may be performed. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), an enhanced security device 619, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 602 for generation and processing of the baseband signals and for controlling operations of the main memory 604, the storage device 616, and/or the enhanced security device 619. The baseband processor may be provided on a single radio card, a single chip, or an integrated circuit (IC).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The enhanced security device 619 may carry out or perform any of the operations and processes (e.g., process 200, process 400) described and shown above.

It is understood that the above are only a subset of what the enhanced security device 619 may be configured to perform and that other functions included throughout this disclosure may also be performed by the enhanced security device 619.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver ZZ20 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

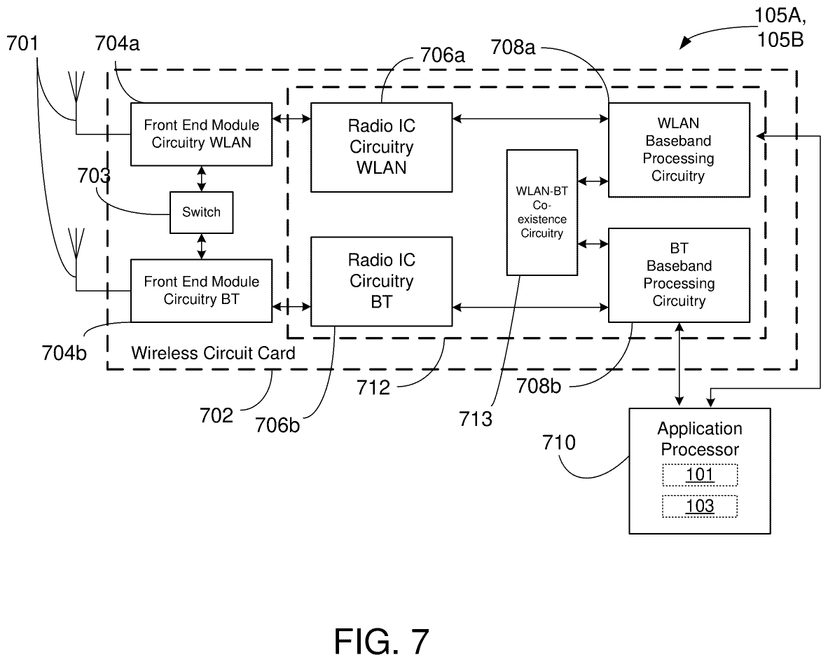

FIG. 7 is a block diagram of a radio architecture 105A, 105B in accordance with some embodiments that may be implemented in any one of the example APs 102 and/or the example STAs 120 of FIG. 1A. Radio architecture 105A, 105B may include radio front-end module (FEM) circuitry 704a-b, radio IC circuitry 706a-b and baseband processing circuitry 708a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 704a-b may include a WLAN or Wi-Fi FEM circuitry 704a and a Bluetooth (BT) FEM circuitry 704b. The WLAN FEM circuitry 704a may include a receive signal path comprising circuitry configured to operate on WLAN RF signals received from one or more antennas 701, to amplify the received signals and to provide the amplified versions of the received signals to the WLAN radio IC circuitry 706a for further processing. The BT FEM circuitry 704b may include a receive signal path which may include circuitry configured to operate on BT RF signals received from one or more antennas 701, to amplify the received signals and to provide the amplified versions of the received signals to the BT radio IC circuitry 706b for further processing. FEM circuitry 704a may also include a transmit signal path which may include circuitry configured to amplify WLAN signals provided by the radio IC circuitry 706a for wireless transmission by one or more of the antennas 701. In addition, FEM circuitry 704b may also include a transmit signal path which may include circuitry configured to amplify BT signals provided by the radio IC circuitry 706b for wireless transmission by the one or more antennas. In the embodiment of FIG. 7, although FEM 704a and FEM 704b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 706a-b as shown may include WLAN radio IC circuitry 706a and BT radio IC circuitry 706b. The WLAN radio IC circuitry 706a may include a receive signal path which may include circuitry to down-convert WLAN RF signals received from the FEM circuitry 704a and provide baseband signals to WLAN baseband processing circuitry 708a. BT radio IC circuitry 706b may in turn include a receive signal path which may include circuitry to down-convert BT RF signals received from the FEM circuitry 704b and provide baseband signals to BT baseband processing circuitry 708b. WLAN radio IC circuitry 706a may also include a transmit signal path which may include circuitry to up-convert WLAN baseband signals provided by the WLAN baseband processing circuitry 708a and provide WLAN RF output signals to the FEM circuitry 704a for subsequent wireless transmission by the one or more antennas 701. BT radio IC circuitry 706b may also include a transmit signal path which may include circuitry to up-convert BT baseband signals provided by the BT baseband processing circuitry 708b and provide BT RF output signals to the FEM circuitry 704b for subsequent wireless transmission by the one or more antennas 701. In the embodiment of FIG. 7, although radio IC circuitries 706a and 706b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 708a-b may include a WLAN baseband processing circuitry 708a and a BT baseband processing circuitry 708b. The WLAN baseband processing circuitry 708a may include a memory, such as, for example, a set of RAM arrays in a Fast Fourier Transform or Inverse Fast Fourier Transform block (not shown) of the WLAN baseband processing circuitry 708a. Each of the WLAN baseband circuitry 708a and the BT baseband circuitry 708b may further include one or more processors and control logic to process the signals received from the corresponding WLAN or BT receive signal path of the radio IC circuitry 706a-b, and to also generate corresponding WLAN or BT baseband signals for the transmit signal path of the radio IC circuitry 706a-b. Each of the baseband processing circuitries 708a and 708b may further include physical layer (PHY) and medium access control layer (MAC) circuitry, and may further interface with a device for generation and processing of the baseband signals and for controlling operations of the radio IC circuitry 706a-b.

Referring still to FIG. 7, according to the shown embodiment, WLAN-BT coexistence circuitry 713 may include logic providing an interface between the WLAN baseband circuitry 708a and the BT baseband circuitry 708b to enable use cases requiring WLAN and BT coexistence. In addition, a switch 703 may be provided between the WLAN FEM circuitry 704a and the BT FEM circuitry 704b to allow switching between the WLAN and BT radios according to application needs. In addition, although the antennas 701 are depicted as being respectively connected to the WLAN FEM circuitry 704a and the BT FEM circuitry 704b, embodiments include within their scope the sharing of one or more antennas as between the WLAN and BT FEMs, or the provision of more than one antenna connected to each of FEM 704a or 704b.

In some embodiments, the front-end module circuitry 704a-b, the radio IC circuitry 706a-b, and baseband processing circuitry 708a-b may be provided on a single radio card, such as wireless radio card 702. In some other embodiments, the one or more antennas 701, the FEM circuitry 704a-b and the radio IC circuitry 706a-b may be provided on a single radio card. In some other embodiments, the radio IC circuitry 706a-b and the baseband processing circuitry 708a-b may be provided on a single chip or integrated circuit (IC), such as IC 712.

In some embodiments, the wireless radio card 702 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect. In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 7, the BT baseband circuitry 708b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHZ, 2.4 GHz, 5 GHZ, and bandwidths of about 2 MHz, 4 MHZ, 5 MHz, 5.5 MHz, 6 MHz, 8 MHz, 10 MHz, 20 MHz, 40 MHz, 80 MHZ (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

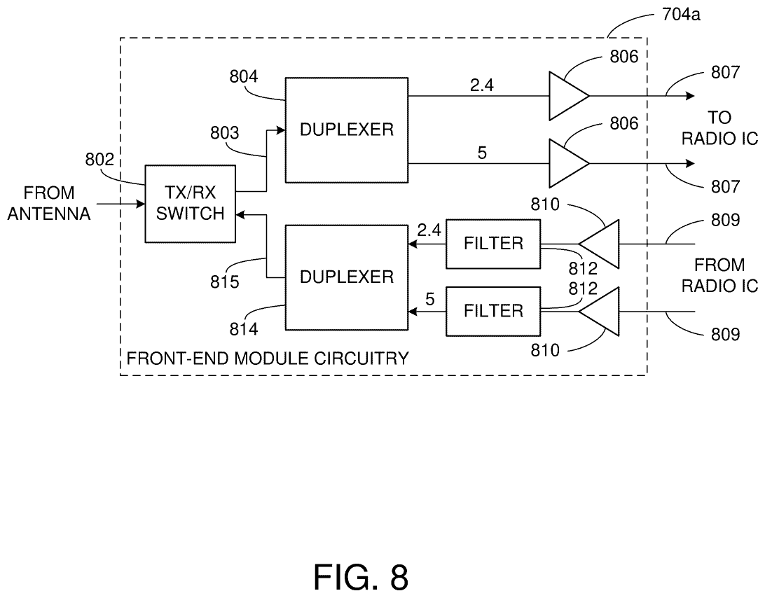

FIG. 8 illustrates WLAN FEM circuitry 804a in accordance with some embodiments. Although the example of FIG. 8 is described in conjunction with the WLAN FEM circuitry 804a, the example of FIG. 8 may be described in conjunction with the example BT FEM circuitry 704b (FIG. 7), although other circuitry configurations may also be suitable.

In some embodiments, the FEM circuitry 704a may include a TX/RX switch 802 to switch between transmit mode and receive mode operation. The FEM circuitry 704a may include a receive signal path and a transmit signal path. The receive signal path of the FEM circuitry 704a may include a low-noise amplifier (LNA) 806 to amplify received RF signals 803 and provide the amplified received RF signals 807 as an output (e.g., to the radio IC circuitry 706a-b (FIG. 7)). The transmit signal path of the circuitry 704a may include a power amplifier (PA) to amplify input RF signals 809 (e.g., provided by the radio IC circuitry 706a-b), and one or more filters 812, such as band-pass filters (BPFs), low-pass filters (LPFs) or other types of filters, to generate RF signals 815 for subsequent transmission (e.g., by one or more of the antennas 701 (FIG. 7)) via an example duplexer 814.

In some dual-mode embodiments for Wi-Fi communication, the FEM circuitry 704a may be configured to operate in either the 2.4 GHz frequency spectrum or the 5 GHz frequency spectrum. In these embodiments, the receive signal path of the FEM circuitry 704a may include a receive signal path duplexer 804 to separate the signals from each spectrum as well as provide a separate LNA 806 for each spectrum as shown. In these embodiments, the transmit signal path of the FEM circuitry 704a may also include a power amplifier 810 and a filter 812, such as a BPF, an LPF or another type of filter for each frequency spectrum and a transmit signal path duplexer 804 to provide the signals of one of the different spectrums onto a single transmit path for subsequent transmission by the one or more of the antennas 801 (FIG. 8). In some embodiments, BT communications may utilize the 2.4 GHz signal paths and may utilize the same FEM circuitry 804a as the one used for WLAN communications.

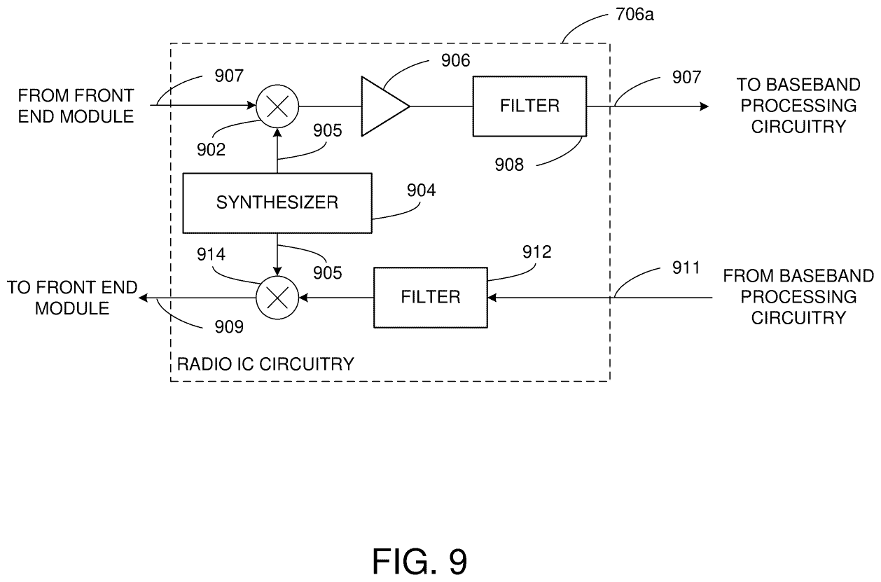

FIG. 9 illustrates radio IC circuitry 706a in accordance with some embodiments. The radio IC circuitry 706a is one example of circuitry that may be suitable for use as the WLAN or BT radio IC circuitry 706a/706b (FIG. 7), although other circuitry configurations may also be suitable. Alternatively, the example of FIG. 9 may be described in conjunction with the example BT radio IC circuitry 706b.

In some embodiments, the radio IC circuitry 706a may include a receive signal path and a transmit signal path. The receive signal path of the radio IC circuitry 706a may include at least mixer circuitry 902, such as, for example, down-conversion mixer circuitry, amplifier circuitry 906 and filter circuitry 908. The transmit signal path of the radio IC circuitry 706a may include at least filter circuitry 912 and mixer circuitry 914, such as, for example, up-conversion mixer circuitry. Radio IC circuitry 706a may also include synthesizer circuitry 904 for synthesizing a frequency 905 for use by the mixer circuitry 902 and the mixer circuitry 914. The mixer circuitry 902 and/or 914 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 9 illustrates only a simplified version of a radio IC circuitry, and may include, although not shown, embodiments where each of the depicted circuitries may include more than one component. For instance, mixer circuitry 914 may each include one or more mixers, and filter circuitries 908 and/or 912 may each include one or more filters, such as one or more BPFs and/or LPFs according to application needs. For example, when mixer circuitries are of the direct-conversion type, they may each include two or more mixers.

In some embodiments, mixer circuitry 902 may be configured to down-convert RF signals 807 received from the FEM circuitry 704a-b (FIG. 7) based on the synthesized frequency 905 provided by synthesizer circuitry 904. The amplifier circuitry 906 may be configured to amplify the down-converted signals and the filter circuitry 908 may include an LPF configured to remove unwanted signals from the down-converted signals to generate output baseband signals 907. Output baseband signals 907 may be provided to the baseband processing circuitry 708a-b (FIG. 7) for further processing. In some embodiments, the output baseband signals 907 may be zero-frequency baseband signals, although this is not a requirement. In some embodiments, mixer circuitry 902 may comprise passive mixers, although the scope of the embodiments is not limited in this respect.

In some embodiments, the mixer circuitry 914 may be configured to up-convert input baseband signals 911 based on the synthesized frequency 905 provided by the synthesizer circuitry 904 to generate RF output signals 809 for the FEM circuitry 704a-b. The baseband signals 911 may be provided by the baseband processing circuitry 708a-b and may be filtered by filter circuitry 912. The filter circuitry 912 may include an LPF or a BPF, although the scope of the embodiments is not limited in this respect.

In some embodiments, the mixer circuitry 902 and the mixer circuitry 914 may each include two or more mixers and may be arranged for quadrature down-conversion and/or up-conversion respectively with the help of synthesizer 904. In some embodiments, the mixer circuitry 902 and the mixer circuitry 914 may each include two or more mixers each configured for image rejection (e.g., Hartley image rejection). In some embodiments, the mixer circuitry 902 and the mixer circuitry 914 may be arranged for direct down-conversion and/or direct up-conversion, respectively. In some embodiments, the mixer circuitry 902 and the mixer circuitry 914 may be configured for super-heterodyne operation, although this is not a requirement.

Mixer circuitry 902 may comprise, according to one embodiment: quadrature passive mixers (e.g., for the in-phase (I) and quadrature phase (Q) paths). In such an embodiment, RF input signal 807 from FIG. 8 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 905 of synthesizer 904 (FIG. 9). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 807 (FIG. 8) may comprise a balanced signal, although the scope of the embodiments is not limited in this respect. The I and Q baseband output signals may be provided to low-noise amplifier, such as amplifier circuitry 906 (FIG. 9) or to filter circuitry 908 (FIG. 9).

In some embodiments, the output baseband signals 907 and the input baseband signals 911 may be analog baseband signals, although the scope of the embodiments is not limited in this respect. In some alternate embodiments, the output baseband signals 907 and the input baseband signals 911 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 904 may be a fractional-N synthesizer or a fractional N/N+1 synthesizer, although the scope of the embodiments is not limited in this respect as other types of frequency synthesizers may be suitable. For example, synthesizer circuitry 904 may be a delta-sigma synthesizer, a frequency multiplier, or a synthesizer comprising a phase-locked loop with a frequency divider. According to some embodiments, the synthesizer circuitry 904 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 904 may be provided by a voltage controlled oscillator (VCO), although that is not a requirement. A divider control input may further be provided by either the baseband processing circuitry 808a-b (FIG. 8) depending on the desired output frequency 905. In some embodiments, a divider control input (e.g., N) may be determined from a look-up table (e.g., within a Wi-Fi card) based on a channel number and a channel center frequency as determined or indicated by the example application processor 710. The application processor 710 may include, or otherwise be connected to, one of the example secure signal converter 101 or the example received signal converter 103 (e.g., depending on which device the example radio architecture is implemented in).

In some embodiments, synthesizer circuitry 904 may be configured to generate a carrier frequency as the output frequency 905, while in other embodiments, the output frequency 905 may be a fraction of the carrier frequency (e.g., one-half the carrier frequency, one-third the carrier frequency). In some embodiments, the output frequency 905 may be a LO frequency (fLO).

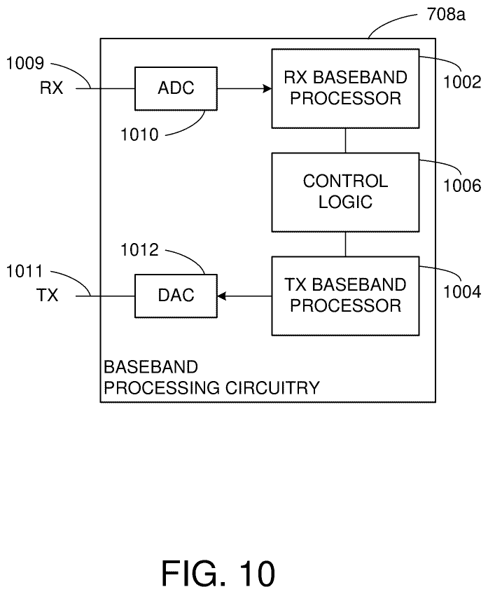

FIG. 10 illustrates a functional block diagram of baseband processing circuitry 708a in accordance with some embodiments. The baseband processing circuitry 708a is one example of circuitry that may be suitable for use as the baseband processing circuitry 708a (FIG. 7), although other circuitry configurations may also be suitable. Alternatively, the example of FIG. 9 may be used to implement the example BT baseband processing circuitry 708b of FIG. 7.

The baseband processing circuitry 708a may include a receive baseband processor (RX BBP) 1002 for processing receive baseband signals 909 provided by the radio IC circuitry 706a-b (FIG. 7) and a transmit baseband processor (TX BBP) 1004 for generating transmit baseband signals 911 for the radio IC circuitry 706a-b. The baseband processing circuitry 708a may also include control logic 1006 for coordinating the operations of the baseband processing circuitry 708a.

In some embodiments (e.g., when analog baseband signals are exchanged between the baseband processing circuitry 708a-b and the radio IC circuitry 706a-b), the baseband processing circuitry 708a may include ADC 1010 to convert analog baseband signals 1009 received from the radio IC circuitry 706a-b to digital baseband signals for processing by the RX BBP 1002. In these embodiments, the baseband processing circuitry 708a may also include DAC 1012 to convert digital baseband signals from the TX BBP 1004 to analog baseband signals 1011.

In some embodiments that communicate OFDM signals or OFDMA signals, such as through baseband processor 708a, the transmit baseband processor 1004 may be configured to generate OFDM or OFDMA signals as appropriate for transmission by performing an inverse fast Fourier transform (IFFT). The receive baseband processor 1002 may be configured to process received OFDM signals or OFDMA signals by performing an FFT. In some embodiments, the receive baseband processor 1002 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 7, in some embodiments, the antennas 701 (FIG. 7) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 701 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may be an apparatus for a device for using encrypted 802.11 association, the device comprising processing circuitry coupled to storage, the processing circuitry configured to: identify a beacon received from an access point (AP), the beacon comprising an indication of an authentication and key manager (AKM); cause the device to transmit, to the AP, an 802.11 authentication request comprising an indication of parameters associated with the AKM; identify an 802.11 authentication response received from the AP based on the 802.11 authentication request, the 802.11 authentication response comprising a message integrity check (MIC) using a key confirmation key (KCK) and an indication that the parameters have been selected by the AP; cause the device to transmit, to the AP, an 802.11 association request encrypted by a security key based on an authenticator address; and identify an 802.11 association response received from the AP based on the 802.11 association request, the 802.11 association response encrypted by the security key.

Example 2 may include the apparatus of example 1 and/or some other example herein, wherein the parameters comprise a pairwise master key identifier (PMKID).

Example 3 may apparatus the device of example 1 and/or some other example herein, wherein a PMKID is absent from the parameters.

Example 4 may include the apparatus of example 1 and/or some other example herein, wherein the parameters comprise an indication that the 802.11 association request will be the next frame transmitted after the 802.11 authentication response.

Example 5 may include the apparatus of example 4 and/or some other example herein, wherein the 802.11 association request comprises a confirmation of authentication of the device to the AP.

Example 6 may include the apparatus of example 4 and/or some other example herein, wherein one bit in the 802.11 authentication request indicates that an authentication confirmation message of an 802.11 pre-association security negotiation (PASN) exchange is to be replaced with the 802.11 association request and that the 802.11 association request comprises content of the authentication confirmation message of the 802.11 PSAN exchange.

Example 7 may include the apparatus of example 6 and/or some other example herein, wherein a key derivation formula used by the 802.11 PASN exchange is modified to replace a basic service set identifier (BSSID) with an authenticator address and to derive the security key.

Example 8 may include the apparatus of example 6 and/or some other example herein, wherein the security key is a transient key generated based on the 802.11 authentication request and the 802.11 authentication response.

Example 9 may include the apparatus of example 6 and/or some other example herein, wherein the security key is different than a transient key generated based on the 802.11 authentication request and the 802.11 authentication response.

Example 10 may include the apparatus of example 6 and/or some other example herein, wherein the processing circuitry is further configured to cause the device to transmit, to the AP, after the 802.11 authentication response and before the 802.11 association request, a confirmation of authentication of the device to the AP.

Example 11 may include the apparatus of example 1 and/or some other example herein, further comprising a transceiver configured to transmit and receive wireless signals.

Example 12 may include the apparatus of example 11 and/or some other example herein, further comprising an antenna coupled to the transceiver to cause the device to send the 802.11 association request, the 802.11 association response, the beacon, the 802.11 authentication request, and the 802.11 authentication response.

Example 13 may include the apparatus of example 1 and/or some other example herein, wherein the device is a multi-link device.

Example 14 may include a non-transitory computer-readable medium storing instructions to cause processing circuitry of a device for using encrypted 802.11 association, upon execution of the instructions by the processing circuitry, to: identify a beacon received from an access point (AP), the beacon comprising an indication of an authentication and key manager (AKM); cause the device to transmit, to the AP, an 802.11 authentication request comprising an indication of parameters associated with the AKM; identify an 802.11 authentication response received from the AP based on the 802.11 authentication request, the 802.11 authentication response comprising a message integrity check (MIC) using a key confirmation key (KCK) and an indication that the parameters have been selected by the AP; cause the device to transmit, to the AP, an 802.11 association request encrypted by a security key based on an authenticator address of the AP; and identify an 802.11 association response received from the AP based on the 802.11 association request, the 802.11 association response encrypted by the security key.

Example 15 may include the non-transitory computer-readable medium of example 14 and/or some other example herein, wherein the parameters comprise a pairwise master key identifier (PMKID).

Example 16 may include the non-transitory computer-readable medium of example 14 and/or some other example herein, wherein the parameters comprise an indication that the 802.11 association request will be the next frame transmitted after the 802.11 authentication response.

Example 17 may include the non-transitory computer-readable medium of example 14 and/or some other example herein, wherein a PMKID is absent from the parameters.

Example 18 may include a method for using encrypted 802.11 association, the method comprising: identifying, by processing circuitry of a device, a beacon received from an access point (AP), the beacon comprising an indication of an authentication and key manager (AKM); causing, by the processing circuitry, the device to transmit, to the AP, an 802.11 authentication request comprising an indication of parameters associated with the AKM; identifying, by the processing circuitry, an 802.11 authentication response received from the AP based on the 802.11 authentication request, the 802.11 authentication response comprising a message integrity check (MIC) using a key confirmation key (KCK) and an indication that the parameters have been selected by the AP; causing, by the processing circuitry, the device to transmit, to the AP, an 802.11 association request encrypted by a security key based on an authenticator address of the AP; and identifying, by the processing circuitry, an 802.11 association response received from the AP based on the 802.11 association request, the 802.11 association response encrypted by the security key.

Example 19 may include the method of example 18 and/or some other example herein, wherein the parameters comprise a pairwise master key identifier (PMKID), and wherein the parameters comprise an indication that the 802.11 association request will be the next frame transmitted after the 802.11 authentication response.

Example 20 may include the method of example 18 and/or some other example herein, wherein a key derivation formula used by an 802.11 pre-association security negotiation (PASN) exchange is modified to replace a basic service set identifier (BSSID) with an authenticator address and to derive the security key.

Example 21 may include an apparatus comprising means for: identifying a beacon received from an access point (AP), the beacon comprising an indication of an authentication and key manager (AKM); causing a device to transmit, to the AP, an 802.11 authentication request comprising an indication of parameters associated with the AKM; identifying an 802.11 authentication response received from the AP based on the 802.11 authentication request, the 802.11 authentication response comprising a message integrity check (MIC) using a key confirmation key (KCK) and an indication that the parameters have been selected by the AP; causing the device to transmit, to the AP, an 802.11 association request encrypted by a security key based on an authenticator address of the AP; and identifying an 802.11 association response received from the AP based on the 802.11 association request, the 802.11 association response encrypted by the security key.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
derive a Transient Key (TK) and Key Encryption Key (KEK) using a pre-association security negotiation (PASN) exchange;
use ephemeral keys generated during the PASN exchange to secure authentication frames; and
encrypt association and reassociation frames based on the derived TK and KEK;
utilize the TK as an initial TK during association.

2. The device of claim 1, wherein the processing circuitry is further configured to derive the TK and KEK based on a Base key management negotiated during the PASN exchange.

3. The device of claim 1, wherein the processing circuitry is further configured to utilize message integrity code (MIC) for authentication frames during the PASN exchange.

4. The device of claim 1, wherein the processing circuitry is further configured to include Robust Security Network Element (RSNE) parameters during the PASN exchange to indicate a capability of creating robust security network associations (RSNAs).

5. The device of claim 1, wherein the processing circuitry is further configured to use a Protected Master Key Identifier (PMKID) derived during the PASN exchange to enable secure reassociation.

6. The device of claim 1, wherein the processing circuitry is further configured to use the TK derived during the PASN exchange as the initial TK during reassociation.

7. The device of claim 1, wherein the processing circuitry is further configured to select a base key management during the PASN exchange.

8. The device of claim 1, wherein the processing circuitry is further configured to determine whether a valid Pairwise Master Key Security Association (PMKSA) exists, and to treat the PASN exchange as a non-RSNA protocol if no PMKSA or corresponding base key management is available.

9. A non-transitory computer-readable medium storing computer-executable instructions which when executed by one or more processors result in performing operations comprising:
derive a Transient Key (TK) and Key Encryption Key (KEK) using a pre-association security negotiation (PASN) exchange;
using ephemeral keys generated during the PASN exchange to secure authentication frames; and
encrypt association and reassociation frames based on the derived TK and KEK;
utilizing the TK as an initial TK during association.

10. The non-transitory computer-readable medium of claim 9, wherein the operations further comprise derive the TK and KEK based on a Base key management negotiated during the PASN exchange.

11. The non-transitory computer-readable medium of claim 9, wherein the operations further comprise utilizing message integrity code (MIC) for authentication frames during the PASN exchange.

12. The non-transitory computer-readable medium of claim 9, wherein the operations further comprise including Robust Security Network Element (RSNE) parameters during the PASN exchange to indicate a capability of creating robust security network associations (RSNAs).

13. The non-transitory computer-readable medium of claim 9, wherein the operations further comprise using a Protected Master Key Identifier (PMKID) derived during the PASN exchange to enable secure reassociation.

14. The non-transitory computer-readable medium of claim 9, wherein the operations further comprise using the TK derived during the PASN exchange as the initial TK during reassociation.

15. The non-transitory computer-readable medium of claim 9, wherein the operations further comprise selecting a base key management during the PASN exchange.

16. The non-transitory computer-readable medium of claim 9, wherein the operations further comprise determining whether a valid Pairwise Master Key Security Association (PMKSA) exists, and to treat the PASN exchange as a non-RSNA protocol if no PMKSA or corresponding base key management is available.

17. A method comprising:
derive a Transient Key (TK) and Key Encryption Key (KEK) using a pre-association security negotiation (PASN) exchange;
using ephemeral keys generated during the PASN exchange to secure authentication frames; and
encrypt association and reassociation frames based on the derived TK and KEK;
utilizing the TK as an initial TK during association.

18. The method of claim 17, further comprising derive the TK and KEK based on a Base key management negotiated during the PASN exchange.

19. The method of claim 17, further comprising utilizing message integrity code (MIC) for authentication frames during the PASN exchange.

20. The method of claim 17, further comprising including Robust Security Network Element (RSNE) parameters during the PASN exchange to indicate a capability of creating robust security network associations (RSNAs).
